(19) United States
(12) Patent Application Publication
(10) Pub. No.: US 2017/0167887 A1
(43) Pub. Date: Jun. 15, 2017

(54) AUDIO VIDEO NAVIGATION DEVICE AND METHOD FOR PROVIDING CHARGING STATION INFORMATION USING THE AUDIO VIDEO NAVIGATION DEVICE

(71) Applicant: Hyundai Motor Company, Seoul (KR)

(72) Inventors: Hye Jin Choi, Suwon (KR); Sang Yeon Lim, Seongnam (KR); Jake Gin, Seongnam (KR); Yeonji Kim, Seoul (KR); Yongho Lee, Hwaseong (KR); Jeong Won Lee, Suwon (KR); Hyun Seung Yang, Seongnam (KR); Sung Tae Cho, Uiwang (KR)

(21) Appl. No.: 15/159,056

(22) Filed: May 19, 2016

(30) Foreign Application Priority Data
Dec. 10, 2015 (KR) 10-2015-0176342

(51) Int. Cl. G01C 21/36

(52) U.S. Cl. CPC G01C 21/3682; G01C 21/3629

(57) ABSTRACT

An audio-video-navigation device of a vehicle includes: an input interface receiving power information of the vehicle through inter-vehicle communication; a memory storing map information; a user input portion generating an input signal corresponding to a demand of a user; a global positioning system (GPS) receiving a signal transmitted from a GPS satellite; a controller connected to the input interface, the memory, the user input portion, and the GPS; and a display portion displaying information processed by the controller. When power of the vehicle is turned on, the controller determines whether first information regarding a charging station nearest to a position of the vehicle at a time at which power of the vehicle was previously turned off is stored in the memory and controls the display portion so as to display an object representing the first information when the first information is stored in the memory.

### CROSS-REFERENCE TO RELATED APPLICATION

This application claims priority to and the benefit of Korean Patent Application No. 10-2015-0176342 filed in the Korean Intellectual Property Office on Dec. 10, 2015, the entire contents of which are incorporated herein by reference.

### BACKGROUND OF THE DISCLOSURE

(a) Technical Field

The present disclosure relates generally to an audio video navigation device and, more particularly, to a method for providing charging station information using the audio video navigation device.

(b) Description of the Related Art

Development of environmentally-friendly vehicles has become very important recently. Vehicle makers are focusing on the development of environmentally-friendly vehicles so as to meet environmental and fuel consumption regulations. Vehicle makers also desire to develop vehicles that meet exhaust gas regulations and improve fuel efficiency performance. Therefore, the vehicle makers have been developing vehicles, such as electric vehicles (EV) and fuel cell electric vehicles (FCEV).

Generally, the existing gas station infrastructure is sufficient for gasoline vehicles and diesel vehicles, it is possible to easily supply gasoline fuel and diesel fuel. However, the electric vehicle and fuel cell vehicle are driven by a driving motor generating torque through electrical energy. Therefore, since the typical gas station infrastructure is not sufficient for electric vehicles and fuel cell electric vehicles, it is difficult to supply electricity or hydrogen to such vehicles at an appropriate time.

In addition, most currently used audio-video-navigation (AVN) devices cannot appropriately provide charging station information to users, such as drivers. Thus, drivers of electric vehicles or fuel cell electric vehicles need to perform a large number of steps in order to search for a desired charging station. Specifically, after an AVN device is booted and functions of the AVN device are activated, a driver needs to select a menu for searching for a destination and needs to search a name of a desired charging station.

The above information disclosed in this Background section is only for enhancement of understanding of the background of the disclosure, and therefore, it may contain information that does not form the related art that is already known to a person of ordinary skill in the art.

### SUMMARY OF THE DISCLOSURE

The present disclosure has been made in an effort to provide an audio-video-navigation device and a method for providing charging station information using the audio-video-navigation device having advantages of efficiently providing the charging station information.

According to embodiments of the present disclosure, an audio-video-navigation device of a vehicle includes: an input interface receiving power information of the vehicle through inter-vehicle communication; a memory storing map information; a user input portion generating an input signal corresponding to a demand of a user; a global positioning system (GPS) receiving a signal transmitted from a GPS satellite; a controller connected to the input interface, the memory, the user input portion, and the GPS; and a display portion displaying information processed by the controller. When power of the vehicle is turned on, the controller determines whether first information regarding a charging station nearest to a position of the vehicle at a time at which power of the vehicle was previously turned off is stored in the memory and controls the display portion so as to display an object representing the first information when the first information is stored in the memory.

The first information may include an identifier of the charging station and a distance between the position of the vehicle at the time at which the power of the vehicle was previously turned off and a position of the charging station.

The audio-video-navigation device may further include a communicator wirelessly communicating with a telematics server, wherein the controller may receive second information regarding the charging station from the telematics server and control the display portion so as to display the second information when the object representing the first information is selected.

The second information may include an identifier of the charging station, a distance between a current position of the vehicle and a position of the charging station, and a current state of the charging station.

When the vehicle is stopped, the controller may store information regarding a charging station nearest to a current position of the vehicle in the memory as the first information based on charging station information received from the telematics server.

When the object representing the first information is selected, the controller may control the display portion so as to display a route from a current position of the vehicle to a position of the charging station.

While the vehicle is traveling, the controller may store information regarding a charging station nearest to a current position of the vehicle in the memory as the first information using map information stored in the memory.

The input interface may receive fuel amount information of the vehicle through the inter-vehicle communication, and the controller may display the object representing the first information when the first information is stored in the memory and a fuel amount of the vehicle based on the fuel amount information is less than a predetermined level.

Fuel of the vehicle may be electricity or hydrogen.

The vehicle may be driven by a motor generating torque through electrical energy.

Furthermore, according to embodiments of the present disclosure, a method for providing charging station information using an audio-video-navigation device includes: determining whether power of the vehicle is turned on; when the power of the vehicle is turned on, determining whether first information regarding a charging station nearest to a position of the vehicle at a time at which the power of the vehicle was previously turned off is stored in a memory; and when the first information is stored in the memory, displaying an object representing the first information.

The first information may include an identifier of the charging station and a distance between the position of the vehicle at the time at which the power of the vehicle was previously turned off and a position of the charging station.

The method may further include receiving second information regarding the charging station from a telematics server; and displaying the second information when the object representing the first information is selected.

The second information may include an identifier of the charging station, a distance between a current position of the vehicle and a position of the charging station, and a current state of the charging station.

The method may further include storing information regarding a charging station nearest to a current position of the vehicle in the memory as the first information based on charging station information received from the telematics server when the vehicle is stopped.

The method may further include displaying a route from a current position of the vehicle to a position of the charging station when the object representing the first information is selected.

The method may further include storing information regarding a charging station nearest to a current position of the vehicle in the memory as the first information using map information stored in the memory while the vehicle is traveling.

The method may further include receiving fuel amount information of the vehicle through inter-vehicle communication, and displaying the object representing the first information when the first information is stored in the memory and a fuel amount of the vehicle based on the fuel amount information is less than a predetermined level.

Fuel of the vehicle may be electricity or hydrogen.

The vehicle may be a driven by a motor generating torque through electrical energy.

Accordingly, charging station information may be efficiently provided to a user even in a situation where charging station infrastructure is insufficient.

### BRIEF DESCRIPTION OF THE DRAWINGS

FIG. 1 is a block diagram of an audio video navigation device according to embodiments of the present disclosure.

FIG. 2 is a flowchart of a method for providing charging station information according to embodiments of the present disclosure.

FIG. 3 is a flowchart of a method of storing information regarding a charging station nearest to a current position of a vehicle as first information according to embodiments of the present disclosure.

FIG. 4 is a drawing illustrating charging station information displayed on a display portion according to embodiments of the present disclosure.

FIG. 5 is a drawing illustrating second information displayed on a display portion according to embodiments of the present disclosure.

<Description of symbols>

| | | | |
|---|---|---|---|
| 100: | AVN device | 110: | communicator |
| 120: | input interface | 130: | memory |
| 140: | user input portion | 150: | controller |
| 160: | output portion | 170: | GPS |
| 200: | telematics server | | |

### DETAILED DESCRIPTION OF THE EMBODIMENTS

Hereinafter, the present disclosure will be described more fully with reference to the accompanying drawings, in which embodiments of the disclosure are shown. However, the present disclosure is not limited to the embodiments which are described herein, and may be modified in various different ways. In addition, each configuration illustrated in the drawings is shown for better understanding, for demonstration purposes, and ease of description, but the present disclosure is not limited thereto.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

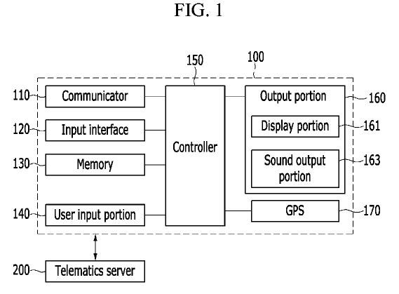

Referring now to the presently disclosed embodiments, FIG. 1 is a block diagram of an audio video navigation device according to embodiments of the present disclosure.

An audio-video-navigation (AVN) device 100 according to embodiments of the present disclosure may be mounted in an electric vehicle or a fuel cell electric vehicle (hereinafter referred to, simply, as a “vehicle”) using electricity or hydrogen as a fuel. In other words, the AVN device 100 may be mounted in a vehicle driven by a driving motor generating torque through electrical energy.

As shown in FIG. 1, the AVN device 100 includes a communicator 110, an input interface 120, a memory 130, a user input portion 140, a controller 150, an output portion 160, and a global positioning system (GPS) 170.

The communicator 110 may transmit and receive a wireless signal to and from a telematics server 200 provided in a telematics center through a wireless network. The communicator 110 may transmit a current position of the vehicle to the telematics server 200. In addition, the communicator 110 may receive map information, road information, traffic information, weather information, and charging station information from the telematics server 200.

The input interface 120 may receive vehicle information through inter-vehicle communication (e.g., controller area network (CAN) communication). The vehicle information may include power information, fuel amount information, and vehicle speed information. Specifically, the power information represents information regarding whether power of the vehicle is turned on or off. The fuel amount information represents information regarding a current fuel state of the vehicle. The vehicle speed information represents information regarding a current speed of the vehicle.

The memory 130 may store input/output data. The memory 130 may store map information for guiding a route. The map information may be updated by receiving map information transmitted from the telematics server 200.

The user input portion 140 generates an input signal corresponding to a demand of a user such as a driver. The user input portion 140 may include a touch pad, a key pad, button(s), switch(es), dial(s), and the like. Particularly, when the touch pad and a display portion 161, which will be described below, form a layer structure, the touch pad may be called a touch screen.

The controller 150 may be implemented with one or more processors executed by a predetermined program, as described above, and the predetermined program may include a series of commands for performing each step included in a method for providing charging station information according to embodiments of the present disclosure.

The output portion 160 generates an output related to a visual or auditory sense, and includes the display portion 161 and a sound output portion 163. The display portion 161 may display information processed by the controller 150. The display portion 161 may display a user interface (UI) or a graphics user interface (GUI) related to route guidance when the AVN device 100 is guiding a route. In addition, the display portion 161 may display the UI or GUI related to a music play function when the AVN device 100 plays a music file.

The sound output portion 163 may output audio data stored in the memory 130. The sound output portion 163 may output a sound signal related to a function (e.g., the route guidance) performed by the AVN device 100.

The GPS 170 receives GPS signals transmitted from three or more GPS satellites. The controller 150 may calculate a current position of the vehicle based on the GPS signals.

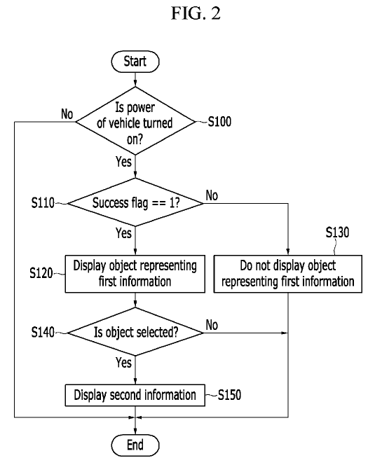

Hereinafter, a method for providing charging station information according to embodiments of the present disclosure will be described in more detail with reference to FIGS. 2 to 5.

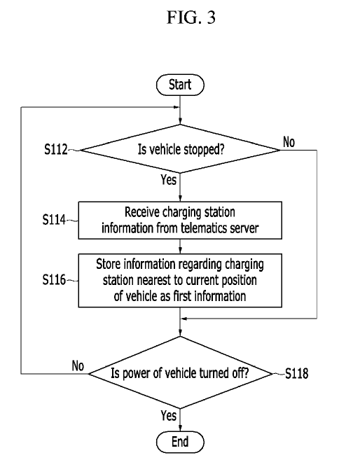

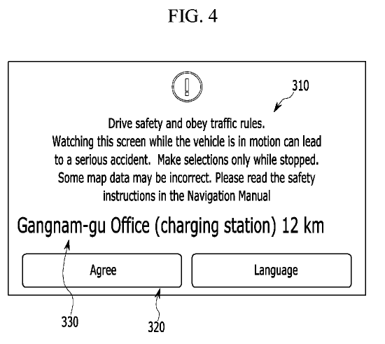

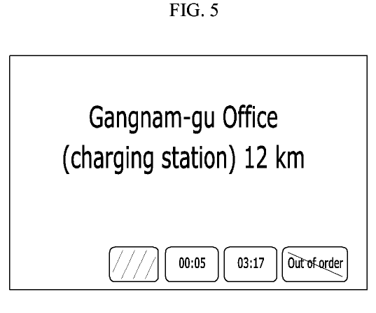

FIG. 2 is a flowchart of a method for providing charging station information according to embodiments of the present disclosure, FIG. 3 is a flowchart of a method of storing information regarding a charging station nearest to a current position of a vehicle as first information according to embodiments of the present disclosure, FIG. 4 is a drawing illustrating charging station information displayed on a display portion according to embodiments of the present disclosure, and FIG. 5 is a drawing illustrating second information displayed on a display portion according to embodiments of the present disclosure.

As shown in FIG. 2, the controller 150 determines whether power of the vehicle is turned on at step S100. The controller 150 may determine whether the power of the vehicle is turned on based on the power information of the vehicle received from the input interface 120.

When the power of the vehicle is not turned on at step S100, the controller 150 finishes the method for providing the charging station information according to embodiments of the present disclosure. In other words, the AVN device 100 is not booted.

When the power of the vehicle is turned on at step S100, the controller 150 determines whether first information regarding a charging station nearest to a position of the vehicle at a time at which power of the vehicle was previously turned off is stored in the memory 130 at step S110.

Referring to FIG. 3, the controller 150 determines whether the vehicle is stopped at step S112. The controller 150 may determine whether the vehicle is stopped based on the vehicle speed information received from the input interface 120.

When the vehicle is stopped at step S112, the controller 150 receives the charging station information from the telematics server 200 at step S114. Alternatively, the controller 150 may receive the charging station information from the telematics server 200 for each predetermined period.

The controller 150 stores information regarding a charging station nearest to a current position of the vehicle in the memory 130 as the first information using the charging station information received from the telematics server 200 at step S116. In other words, the information regarding the charging station nearest the current position of the vehicle may be updated based on the charging station information received from the telematics server 200. The controller 150 may set a success flag to 1 when the information regarding the charging station nearest to the current position of the vehicle is stored as the first information. Accordingly, when the AVN device 100 is booted (i.e., powered on) and the success flag is set to 1, the controller 150 may determine that the first information is stored in the memory 130.

The controller 150 determines whether the power of the vehicle is turned off at step S118. The controller 150 may determine whether the power of the vehicle is turned off based on the power information of the vehicle received from the input interface 120.

When the power of the vehicle is turned off at step S118, information regarding the charging station nearest to the last stopped position of the vehicle is stored in the memory 130 as the first information. In other words, the first information regarding the charging station nearest to the position of the vehicle at the time at which the power of the vehicle is turned off is stored in the memory 130.

When the power of the vehicle is not turned off at step S118, the controller 150 repeats steps S112 to S116.

When the first information is stored in the memory 130 at step S110, the controller 150 may control the display portion 161 to display a predetermined image at step S120. As shown in FIG. 4, the predetermined image may include information 310 for checking whether to activate a navigation function of the AVN device 100. The navigation function may be activated when the user touches a predetermined object 320. The object refers to information that is selected and controlled by an intention of the user. For example, the object may include, for example, an icon, text, contents, a list, and the like. The predetermined image may further include an object 330 representing the first information. The object 330 representing the first information may include an identifier of the charging station and a distance between the position of the vehicle at the time at which the power of the vehicle was turned off and a position of the charging station.

When the success flag is not set to 1 at step S110, the controller 150 may display an image except for the object 330 representing the first information at step S130. In this case, when the user touches the predetermined object 320, a conventional navigation function may be provided.

When the object 330 representing the first information is displayed at step S120, the controller 150 determines whether the object 330 is selected at step S140.

When the object 330 representing the first information is selected at step S140, the controller 150 may receive second information regarding the charging station from the telematics server to display the second information at step S150. In detail, the navigation function is activated when the object 330 representing the first information is selected, and the controller 150 may receive newest information regarding the charging station from the telematics server 200. The second information may include an identifier of the charging station, a distance between a current position of the vehicle and a position of the charging station, and a current state of the charging station (e.g., whether charging services are currently available and the number of available chargers). For example, when the second information is displayed as shown in FIG. 5, it may be verified that four chargers are provided in the charging station, a first charger is currently available, second and third charges are occupied by other vehicles, and a fourth charger is out of order.

When the object 330 representing the first information is not selected at step S140, the controller 150 finishes the method for providing the charging station information according to embodiments of the present disclosure. In this case, when the user touches the predetermined object 320, the conventional navigation function may be provided.

Meanwhile, the controller 150 may determine whether to display the object 330 representing the first information by further considering a fuel amount of the vehicle at step S110. In detail, when the first information is stored in the memory 130 and a fuel amount of the vehicle is less than a predetermined level, the controller 150 may display the object 330 representing the first information. In this case, the controller may notify an appropriate time for charging the vehicle.

Meanwhile, if the object 330 representing the first information is selected at step S140, the controller 150 may calculate and display a route from the current position of the vehicle to the position of the charging station. In other words, the user may easily set the desired charging station as a destination without additional steps for searching for the charging station.

As described above, according to embodiments of the present disclosure, the charging information may be efficiently provided even under a situation where charging station infrastructure is insufficient.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An audio-video-navigation device of a vehicle, comprising:
an input interface receiving power information of the vehicle through inter-vehicle communication;
a memory storing map information;
a user input portion generating an input signal corresponding to a demand of a user;
a global positioning system (GPS) receiving a signal transmitted from a GPS satellite;
a controller connected to the input interface, the memory, the user input portion, and the GPS; and
a display portion displaying information processed by the controller,
wherein when power of the vehicle is turned on, the controller determines whether first information regarding a charging station nearest to a position of the vehicle at a time at which power of the vehicle was previously turned off is stored in the memory and controls the display portion so as to display an object representing the first information when the first information is stored in the memory.

2. The audio-video-navigation device of claim 1, wherein the first information includes an identifier of the charging station and a distance between the position of the vehicle at the time at which the power of the vehicle was previously turned off and a position of the charging station.

3. The audio-video-navigation device of claim 1, further comprising a communicator wirelessly communicating with a telematics server,
wherein the controller receives second information regarding the charging station from the telematics server and controls the display portion so as to display the second information when the object representing the first information is selected.

4. The audio-video-navigation device of claim 3, wherein the second information includes an identifier of the charging station, a distance between a current position of the vehicle and a position of the charging station, and a current state of the charging station.

5. The audio-video-navigation device of claim 3, wherein when the vehicle is stopped, the controller stores information regarding a charging station nearest to a current position of the vehicle in the memory as the first information based on charging station information received from the telematics server.

6. The audio-video-navigation device of claim 1, wherein when the object representing the first information is selected, the controller controls the display portion so as to display a route from a current position of the vehicle to a position of the charging station.

7. The audio-video-navigation device of claim 1, wherein while the vehicle is traveling, the controller stores information regarding a charging station nearest to a current position of the vehicle in the memory as the first information using map information stored in the memory.

8. The audio-video-navigation device of claim 1, wherein:
the input interface receives fuel amount information of the vehicle through the inter-vehicle communication, and
the controller displays the object representing the first information when the first information is stored in the memory and a fuel amount of the vehicle based on the fuel amount information is less than a predetermined level.

9. The audio-video-navigation device of claim 1, wherein fuel of the vehicle is electricity or hydrogen.

10. The audio-video-navigation device of claim 1, wherein the vehicle is driven by a motor generating torque through electrical energy.

11. A method for providing charging station information using an audio-video-navigation device of a vehicle, comprising:
determining whether power of the vehicle is turned on;
when the power of the vehicle is turned on, determining whether first information regarding a charging station nearest to a position of the vehicle at a time at which the power of the vehicle was previously turned off is stored in a memory; and
when the first information is stored in the memory, displaying an object representing the first information.

12. The method of claim 11, wherein the first information includes an identifier of the charging station and a distance between the position of the vehicle at the time at which the power of the vehicle was previously turned off and a position of the charging station.

13. The method of claim 11, further comprising:
receiving second information regarding the charging station from a telematics server; and
displaying the second information when the object representing the first information is selected.

14. The method of claim 13, wherein the second information includes an identifier of the charging station, a distance between a current position of the vehicle and a position of the charging station, and a current state of the charging station.

15. The method of claim 13, further comprising storing information regarding a charging station nearest to a current position of the vehicle in the memory as the first information based on charging station information received from the telematics server when the vehicle is stopped.

16. The method of claim 11, further comprising displaying a route from a current position of the vehicle to a position of the charging station when the object representing the first information is selected.

17. The method of claim 11, further comprising storing information regarding a charging station nearest to a current position of the vehicle in the memory as the first information using map information stored in the memory while the vehicle is traveling.

18. The method of claim 11, further comprising:
receiving fuel amount information of the vehicle through inter-vehicle communication; and
displaying the object representing the first information when the first information is stored in the memory and a fuel amount of the vehicle based on the fuel amount information is less than a predetermined level.

19. The method of claim 11, wherein fuel of the vehicle is electricity or hydrogen.

20. The method of claim 11, wherein the vehicle is a driven by a motor generating torque through electrical energy.
